(19) United States
(12) Patent Application Publication
(10) Pub. No.: US 2025/0012920 A1
(43) Pub. Date: Jan. 9, 2025

(54) METHOD, DEVICE AND SYSTEM FOR OPERATING A RAIL VEHICLE FOR WARNING ABOUT A POSSIBLE COLLISION

(71) Applicant: Robert Bosch GmbH, Stuttgart (DE)

(72) Inventors: Patrick Haecker, Ilsfeld (DE); Heiko Mangold, Mosbach (DE); Ruprecht Anz, Lehrensteinsfeld (DE)

(21) Appl. No.: 18/708,389

(22) PCT Filed: Nov. 9, 2022
(86) PCT No.: PCT/EP2022/081303

§ 371 Date: May 8, 2024

(30) Foreign Application Priority Data
Nov. 11, 2021 (DE) 10 2021 212 700.2

(51) Int. Cl. G01S 13/931; B61L 23/04; G01S 13/536

(52) U.S. Cl. CPC G01S 13/931; B61L 23/041; G01S 13/536; G01S 2013/93271; G01S 2013/93272; G01S 2013/9328

(57) ABSTRACT

A method for operating a rail vehicle with radar sensors arranged at both ends of the vehicle. The method includes: carrying out an object detection of upcoming obstacles and objects by operating a radar sensor in the direction of travel in normal mode, in which an obstacle detection of approaching objects ahead in the roadway is carried out based an a radar detection; detecting an approaching object, if a superimposed determined radar pulse pattern is received in the radar detection with the radar sensor in normal mode, wherein the determined radar pulse pattern corresponds to a radar pulse pattern that deviates from a radar transmission signal in normal operation.

### FIELD

The present invention relates to rail vehicles, and in particular to measures for detecting a risk of collision using a radar sensor. In particular, the present invention relates to measures for detecting a risk of collision with another rail vehicle.

### BACKGROUND INFORMATION

Rail vehicles that run on sight, such as streetcars, passenger or freight trains and the like, are usually equipped with collision warning systems that can warn a driver of a possible collision in critical situations or also initiate automatic braking. For example, such collision warning systems use environmental sensors, such as video sensors or radar sensors, which are installed at the front of the rail vehicle and can detect other rail vehicles or other obstacles ahead or on the roadway.

The use of video sensors is complex, since they have to be trained on different types of objects, in particular types of rail vehicles, and have poorer detection accuracy in poor visibility, such as fog or darkness, and poor lighting, such as in a tunnel. The use of lidar sensors is generally less robust for object detection in the event of sensor contamination, which often occurs in the vicinity of rail vehicles.

German Patent Application No. DE 10 2019 107 653 A1 describes a method for determining a risk of collision between a moving object and a foreign object located in the vicinity of the object, wherein the object has a distance to the foreign object and the object moves at a current object velocity relative to the foreign object, wherein an actual distance threshold value is ascertained as a function of a base distance threshold value adapted with the aid of at least one state parameter, it is determined whether there is a risk of collision by comparing the distance value provided with the actual distance threshold value, and state information as to whether or not there is a risk of collision is generated and output.

In rail vehicles with two directions of travel, there are sensor systems at both vehicle ends, wherein in each case the rear sensor system is either deactivated or not evaluated.

Other concepts can provide that the rail vehicles communicate their current position, speed and direction to other rail vehicles based on radio-based vehicle-to-vehicle communication in order to thus detect critical approaches. For this purpose, it is necessary to determine the position with a high degree of accuracy, in order to enable a high degree of reliability in the detection of approaching objects and a low false warning rate at the same time. This is particularly difficult when localizing and determining the direction of travel in unfavorable conditions, such as tunnels. However, other obstacles or other rail vehicles in the roadway of the rail vehicle that are not equipped for vehicle-to-vehicle communication cannot be detected.

### SUMMARY

According to the present invention, a method for operating a rail vehicle for detecting a possible collision, a device, a system, a computer program, and a storage medium are provided.

Example embodiments of the present invention are disclosed herein.

According to a first aspect of the present invention, a method for operating a rail vehicle with radar sensors arranged at both ends of the vehicle is provided. According to an example embodiment of the present invention, the method comprises the following steps:
carrying out an object detection of upcoming obstacles and objects by operating a radar sensor in the direction of travel in normal mode, in which an obstacle detection of approaching objects ahead in the roadway is carried out based on a radar detection;
detecting an approaching object, if a superimposed determined radar pulse pattern is received in the radar detection with a radar sensor in normal mode, wherein the determined radar pulse pattern corresponds to a radar pulse pattern that deviates from a radar transmission signal and also from possible reflected radar transmission signals in normal operation.

Furthermore, the determined radar pulse pattern can be transmitted by a further radar sensor in a cooperation mode at the rear end of the rail vehicle with respect to the direction of travel.

The above method relates to a rail vehicle system with which the rail vehicles, such as trains, streetcars or the like, are equipped with radar sensors at both vehicle ends. A fundamental problem with the use of radar sensors for the detection of possible collisions is that radar sensors can detect and classify moving rail vehicles well, but have problems reliably classifying stationary rail vehicles as such, despite successful detection of an object in the roadway, in particular if they are located in a heavily fissured or heavily metalized environment, such as in a tunnel. The method makes it possible to reliably detect approaching rail vehicles, even if one of the rail vehicles is not moving.

Within the framework of the present invention, an object approaching the rail vehicle can be understood as an object whose relative distance to the rail vehicle decreases. This is to say, in other words, the object approaching the rail vehicle approaches the rail vehicle from a perspective or a reference system of the rail vehicle. For example, the object can show no movement and the rail vehicle can move towards the object. It is also possible that the object and the rail vehicle move in the same direction, wherein the speed of the rail vehicle along the direction is greater than the speed of the object.

The above method according to the present invention is based on rail vehicles that are fitted with radar sensors at both the front and rear. This does not require any additional equipment, in particular in the case of these rail vehicles designed as so-called two-directional vehicles, as is often the case with streetcars, for example.

According to an example embodiment of the present invention, the rail vehicles are operated so that the radar sensor operated in the direction of travel is operated in a normal mode, while the radar sensor operated at an opposite rear end of the rail vehicle is operated in cooperation mode. Cooperation mode can be a passive operating mode.

The radar sensors are in each case designed with an antenna, a transmitter unit, a receiver unit and an evaluation unit, which transmit and receive radar signals and evaluate the received radar signals.

According to an example embodiment of the present invention, in normal mode, the radar sensor detects the distance, speed and direction of movement of upcoming objects in the direction of travel in the conventional manner. However, in cooperation mode, the radar sensor is operated in such a way that it outputs a determined radar pulse pattern. This determined radar pulse pattern corresponds to a course of a radar signal that differs from possible courses of radar signals that can be received in normal mode for the detection of upcoming objects, so that as a result another rail vehicle in the direction of travel can be inferred.

According to a preferred example embodiment of the present invention, the determined radar pulse pattern can correspond to a periodic radar signal of constant frequency. However, the course of the radar signal of the determined radar signal pattern can in principle be defined by a periodic sequence of identical or different radar pulses of one or more frequencies, corresponding amplitudes and phases and corresponding pulse durations along with the pauses between the radar pulses.

In particular, a radar signal can be transmitted in normal mode in accordance with FMCW operation with a frequency ramp and a correspondingly received radar signal can be evaluated in order to ascertain a distance, a speed and a direction of movement of objects present in the detection range.

Radar sensors are usually operated using an FMCW-based method (frequency modulated continuous wave), in which mutual interference between radar sensors can occur. These interferences have a high amplitude compared to the rest of the signal, but are very short in time and are detected and filtered out by the radar sensors; in particular, these interferences occur without temporal correlation or always take place at different points in time on different frequencies. As a result, it is possible to distinguish the short-term interferences from the determined radar pulse pattern of a radar sensor operating in cooperation mode, which is regular and present at a determined frequency or frequencies.

In particular, if the output of the determined radar pulse pattern is effected regularly by the radar sensor operating in cooperation mode, the repeated measurement of the determined radar pulse pattern by the radar sensor operating in normal mode of an approaching rail vehicle can be clearly distinguished from random interference after only a short time. Since the determined radar pulse pattern of cooperation mode is known to all rail vehicles, a speed of the approach of the rail vehicle ahead can be determined based on the Doppler shift of the determined radar pulse pattern. In this way, it can be clearly signaled to a rail vehicle that there is another rail vehicle ahead and what its relative speed is. This method also works if a rail vehicle ahead in the direction of travel is not moving.

Since radar sensors in rail vehicles usually have a plurality of receiving antennas that detect an overall wavefront, the direction in which a rail vehicle detected in the direction of travel is located can also be determined, and thus a track-accurate or lane-accurate assignment can be carried out.

In a further example embodiment of the present invention, the determined radar pulse pattern can comprise further information about the type of rail vehicle and its surrounding conditions. Furthermore, according to an example embodiment of the present invention, the determined radar pulse pattern can correspond to a radar signal with variable period and/or variable frequency, wherein the variable period and/or the variable frequency is set according to a measurement of distance and/or speed and/or direction of travel of an upcoming object in the detection range by the radar sensor operating in cooperation mode.

In particular, according to an example embodiment of the present invention, the determined radar pulse pattern can be encoded in such a way that it provides information about a distance measurement with the distance to an approaching rail vehicle detected by the radar sensor operating in cooperation mode. For this purpose, the radar sensor can be operated in cooperation mode to carry out a distance measurement and the distance ascertained in this way can be encoded by the determined radar pulse pattern in order to transmit further distance information to the approaching rail vehicle. The approaching, detecting rail vehicle receives the determined radar pulse pattern and can use this to ascertain information about the distance to the rail vehicle, if present, which has carried out the measurement and whose rear radar sensor is in cooperation mode. If necessary, information about the approach speed can be ascertained from the encoded radar pulse pattern.

According to an example embodiment of the present invention, it can be provided that the measurement of the distance and/or the speed and/or the direction of travel of any object present in the detection range is carried out by the radar sensor operating in cooperation mode during a first time period in periodic alternation with the transmission of the determined radar pulse pattern during a second time period.

According to one example embodiment of the present invention, a signal can be given if an approaching object is detected and there is a risk of collision.

Advantageously, according to an example embodiment of the present invention, it is also ascertained whether the approaching object is in the roadway or on the same track as the rail vehicle when the obstacle detection is carried out. Radar detection with the radar sensor can be used for this purpose. Preferably, based on radar waves received by means of the radar sensor of the rail vehicle, a phase offset of the radar waves with respect to at least two receiving antennas of the radar sensor is ascertained in order to determine the direction of the approaching object relative to the rail vehicle. Preferably, a distance of the approaching object relative to the rail vehicle is also ascertained based on the signal strength of the radar detection or the radar waves received by means of the radar sensor of the rail vehicle. It is also possible that the approaching object transfers information with respect to the distance between the rail vehicle and the approaching object to the rail vehicle by means of a frequency modulation of the radar waves emitted by the approaching object by means of a radar sensor of the approaching object. In addition, information with respect to the course of the rails or tracks can be ascertained by means of a further sensor unit, for example a camera, and/or by means of a localization system, for example GNSS-based, of the rail vehicle relative to a predefined and/or predefinable rail course map. Based on the information with respect to the course of the rails along with the relative distance and relative direction between the rail vehicle and the approaching object, it is possible to ascertain whether the approaching object is in the roadway or on the same track as the rail vehicle. As a result, fault warnings due to rail vehicles on neighboring tracks can be avoided.

According to a further aspect of the present invention, a device, in particular a control unit, is provided for a rail vehicle with radar sensors arranged at both vehicle ends.

According to an example embodiment of the present invention, the device is designed for:
carrying out an object detection of upcoming obstacles and objects by operating a radar sensor in the direction of travel in normal mode, in which an obstacle detection of approaching objects ahead in the roadway is carried out based on a radar detection;
detecting an approaching object, if a superimposed determined radar pulse pattern is received in the radar detection with a radar sensor in normal mode, wherein the determined radar pulse pattern corresponds to a radar pulse pattern that deviates from a radar transmission signal in normal operation.

### BRIEF DESCRIPTION OF THE DRAWINGS

Embodiments are explained in more detail below with reference to the figures.

FIG. 1 shows a schematic illustration of a rail vehicle system with rail vehicles in a situation with a risk of collision.

FIG. 2 shows a flowchart for illustrating a method for operating a sensor system with radar sensors in a rail vehicle, according to an example embodiment of the present invention.

FIG. 3 shows a time signal.

### DETAILED DESCRIPTION OF EXAMPLE EMBODIMENTS

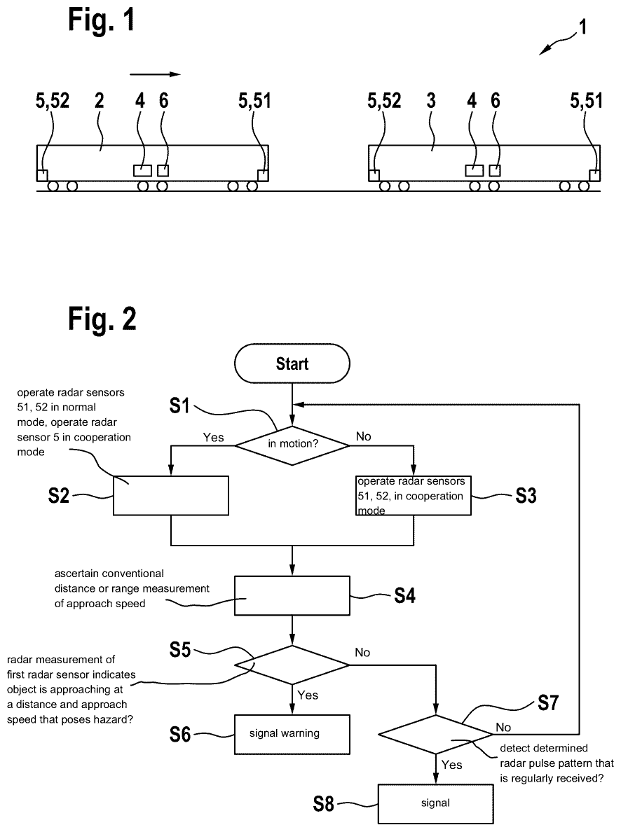

FIG. 1 shows a rail vehicle system 1 with a first, in particular moving rail vehicle 2 and a second rail vehicle 3. In the scenarios shown, the first rail vehicle 2 approaches the second rail vehicle 3 at a predefined speed. The second rail vehicle 3 moves in the same direction or is at a standstill, and in particular near a tunnel opening, so that conventional detection using a radar sensor can be faulty.

The rail vehicles 2, 3 are in each case fitted with a control unit 4 and a sensor system 5. The sensor system 5 has a first radar sensor 51 and a second radar sensor 52 at the ends of the rail vehicle 2, 3. The radar sensors 51, 52 are positioned in the respective longitudinal direction of the rail vehicle 2, 3 with mutually opposite detection directions, which in each case extend in the longitudinal direction of the rail vehicle away from it, in order to detect objects in the direction of movement of the rail vehicle 2, 3. In the present case, the first radar sensors 51 are in each case arranged at the end of the rail vehicle 2, 3 in the direction of travel and the second radar sensors 52 are in each case arranged at the rear end of the respective rail vehicle 2, 3.

The radar sensors can in each case be designed with an antenna, a transmitter unit, a receiver unit and an evaluation unit, which transmit and receive radar signals or evaluate the received radar signals.

Furthermore, an output unit 6 can be provided in order to output a collision warning in the event of a possible collision with an object or another rail vehicle.

The radar sensors 5 can be operated in a normal mode.

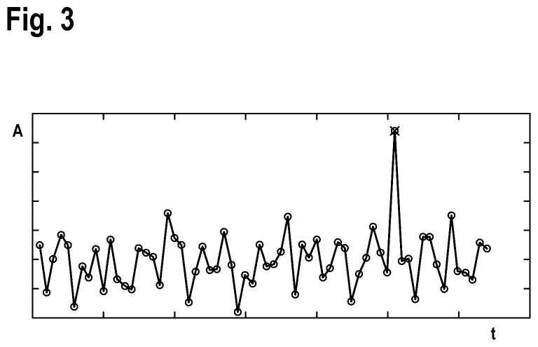

Such a radar sensor 5 can be operated in normal mode according to a conventional FMCW method, with which a transmission spectrum of electromagnetic radiation with a plurality of so-called frequency ramps of varying slopes is passed through and a time signal is recorded during this process. The time signal is then typically Fourier-transformed and further processed in accordance with spectral components, from which a distance, speed and direction of upcoming objects can be ascertained. Such a time signal in terms of the amplitudes is shown in FIG. 3, for example.

However, the time signal in FIG. 3 has an interference in the form of an interference peak marked “x”, which disturbs the Fourier-transformed spectrum and makes it impossible to determine the distance, speed and direction of upcoming objects. This is due to the properties of the Fourier transformation with respect to the transformation of radar pulses. The interference peaks, as shown in FIG. 3 for example, can originate from other radar sensors that also run through the frequency spectrum (with different slopes and phase positions) and transmit for a brief moment at the same frequency as the radar sensor under consideration. Such interference peaks usually have a particularly high amplitude, since the electromagnetic waves normally propagate spherically to and from other objects, and thus an r⁻⁴ behavior results for the power of the received radar signal over the radius r. However, radar transmission signals from other radar sensors at a distance r only exhibit r⁻² behavior and are thus received with a power that is often more than an order of magnitude stronger. Therefore, such interference peaks can be detected and filtered out based on their unusually high amplitudes compared to the other radar signals received, for example by not considering the value of the time signal at the point of time of interference in the Fourier transformation.

A method is carried out in all rail vehicles 2, 3 as described in more detail based on the flow diagram of FIG. 2.

In step S1, there is a check of whether the rail vehicle is in motion. If the rail vehicle is in motion (alternative: Yes), the radar sensor 51, 52, which is in the direction of travel, is operated in a normal mode in step S2, while the radar sensor 5, which is located at the end of the rail vehicle opposite to the direction of travel, is operated in a cooperation mode.

If it is determined in step S1 that the rail vehicle 2, 3 is at a standstill (alternative: No), like the second rail vehicle 3 in the illustrated exemplary embodiment, both radar sensors 51, 52 of the relevant rail vehicle are operated in cooperation mode in step S3.

In a subsequent step S4, a conventional distance or range measurement and a measurement of the approach speed to an upcoming object are ascertained for the radar sensor 5, which is operated in normal operating mode. Based on the radar echo, an identification of the type of upcoming object can be performed.

In step S5, there is a check of whether the radar measurement of the first radar sensor 51 of the first rail vehicle 2, which is operated in normal mode, indicates that an object is approaching at a distance and at an approach speed that could pose a hazard to the rail vehicle. This is determined, for example, by using a threshold value comparison to check the distance with respect to a threshold distance, so that a hazard is present if the first rail vehicle 2 is approaching the object and the distance is less than the predefined threshold distance. In particular, the threshold distance can be determined depending on the speed, so that at lower speeds a risk of collision is only signaled at a smaller threshold distance than at a higher speed. If a risk of collision is detected (alternative: Yes), a warning is signaled to the driver of the first rail vehicle 2 in a subsequent step S6 or a corresponding automatic braking is performed.

If no risk of collision is detected in step S5 (alternative: No), in step S7 there is subsequently a check of whether a determined radar pulse pattern that is regularly received is detected.

This determined radar pulse pattern can be predefined as a periodic radar signal with a constant frequency with radar pulses of a predefined time period of between 50 ms and 500 ms, for example, in particular 100 ms. The pauses in the radar pulse pattern can amount to between 10 ms and 1000 ms. This particular radar pulse pattern corresponds to the transmission mode of the radar sensor 52 operating in cooperation mode. If such a radar pulse pattern is received (alternative: Yes), a second rail vehicle 3 ahead can be detected, which is either stationary or moving in the same direction of travel.

This can be signaled accordingly in step S8. Alternatively (Alternative: No), the method is continued with step S1.

While the moving upcoming second rail vehicle 3 can be detected relatively well by conventional object detection, since the environment of the rail vehicle ahead is changing continuously and thus the profile of the received radar signal changes, with stationary rail vehicles that are in the direction of travel in front of the rail vehicle, it can be problematic to distinguish these from objects located next to tracks, such as tunnel entrances and the like.

In these cases, the regularly determined radar pulse pattern emitted in cooperation mode can be evaluated and detected in the second radar sensor 52 operating in normal mode. Due to the regularly determined radar pulse pattern, the received radar signals can be easily distinguished from interference that can occur in FMCW operation, since the latter is received regularly, while the random interference resulting from FMCW-based operation occurs at time-varying intervals. Thus, the determined radar pulse patterns can be detected based on a corresponding amplitude that is higher than a predefined threshold amplitude, and by their regular time intervals. Thus, the determined radar pulse patterns can be separated from the interference peaks, which certainly occur irregularly in time, due to their regularity and can thus no longer be explained by random interference.

The determined radar pulse patterns can be stored in the first radar sensor 51 of the first rail vehicle 2 and used for an additional direction estimation for which the radar sensors 5 are designed. With this direction estimation and the known course of the roadways of the rail vehicles using corresponding navigation maps, cameras or the like, it is possible to ascertain which roadway the determined radar pulse patterns can be assigned to. If the presence of another rail vehicle is detected on the basis of the frequency of the determined radar pulse patterns and the assignment to the roadways results in an assignment to the vehicle's own roadway, a rail vehicle ahead in the direction of travel can thus be detected.

Since the upcoming rail vehicle can be detected very reliably by the radar sensor even in an adverse environment, but cannot always be classified, both pieces of information can now be combined to classify the upcoming object as a rail vehicle. This rail vehicle can then be warned or braked with a very high degree of reliability.

In this embodiment, the radar sensor 52, which is in cooperation mode, does not perform any radar processing or distance and speed measurement, but merely transmits the determined radar pulse pattern. In addition to rail vehicles ahead, other objects at risk of collision can also be equipped with a corresponding radar sensor 5, which can then be more reliably detected by a collision warning system in the vehicle. For example, light signals, track closures, halls and gates could be equipped with appropriate radar systems.

In a further embodiment, the determined radar pulse pattern can be encoded so that the time intervals of the radar pulses and/or the frequencies of the radar pulses are used to transfer identification information or environment information of the second rail vehicle 3.

Furthermore, in cooperation mode, the second radar sensor 52 can perform a distance measurement so that the second rail vehicle 3 can ascertain the distance to the approaching first rail vehicle 2 and transfer this to the approaching first rail vehicle 2 in a suitable manner by means of the encoded determined radar pulse pattern. For example, the distance to an upcoming object, which was ascertained by the second radar sensor 52 in cooperation mode, can be encoded based on the frequency or the frequency sequence of the radar signals of the determined radar pulse pattern or the radar pulses of the radar pulse pattern, wherein a smaller distance is encoded using the frequency level of the determined radar pulse pattern, for example.

Alternatively, the time interval of the radar pulses can also be varied and thus the distance to the approaching rail vehicle and/or a speed of the approaching rail vehicle can be encoded, so that by evaluating the received radar signals of the determined radar pulse pattern, the approaching first rail vehicle 2 can receive information to check the plausibility of its own radar measurement. In this case, the radar sensors 5 perform a distance and speed measurement both in normal mode and in cooperation mode, wherein in cooperation mode additional radar pulses are emitted in accordance with the determined radar pulse pattern, which enable a radar sensor in normal mode to verify the distance and speed of its own first rail vehicle 2 by means of an external measurement.

The encoding of the distance in the transmission frequency is effected within a predefined frequency band and thus corresponds in principle to frequency modulation. The relationship between the distance of the own first rail vehicle 2 and the second rail vehicle 3 can correspond to a monotonic function. Since the braking distance increases quadratically with the speed, it can be useful to select a quadratic relationship between distance and a frequency of the determined radar pulse pattern within a frequency range in order to better utilize the spectrum in accordance with the criticality or to achieve a higher signal-to-noise ratio.

In addition, a determined frequency can be used for encoding to indicate that no other rail vehicle has been detected within range of the second radar sensor 52. The distance measurement in cooperation mode can be carried out for short time periods, such as during a first time period, such as between 50 and 500 ms, in particular 100 ms, wherein during a second time period of, for example, between 500 ms and 1500 ms, in particular 900 ms, the determined radar pulse pattern is output.

Alternatively, the transmission power received by the first radar sensor 51 of the approaching first rail vehicle 2 can be evaluated. If the transmission characteristics and the direction along with the orientation of the approaching rail vehicle are known, the distance can be ascertained from the power of the received radar signal, since the otherwise unknown radar backscatter cross-section is omitted as a variable in the distance calculation via the power reduction. In addition, the transmission characteristics within structurally identical types of radar sensors are known, so that if only similar radar sensors 5 are used, the direction can be ascertained using a direction estimation from the wavefront received with a plurality of receiving antennas.

1-11. (canceled)

12. A method for operating a rail vehicle with radar sensors arranged at both vehicle ends, the method comprising the following steps:
carrying out an object detection of upcoming obstacles and objects by operating a radar sensor in a direction of travel in normal mode, in which an obstacle detection of approaching objects ahead in a roadway is carried out based an a radar detection; and
detecting an approaching object when a superimposed determined radar pulse pattern is received in a radar detection with the radar sensor in normal mode, wherein the determined radar pulse pattern corresponds to a radar pulse pattern that deviates from a radar transmission signal in normal operation.

13. The method according to claim 12, wherein a radar signal is transmitted in normal mode in accordance with an FMCW operation with a frequency ramp and a correspondingly received radar signal is evaluated in order to ascertain a distance, a speed, and a direction of movement of objects present in the detection range.

14. The method according to claim 12, wherein the determined radar pulse pattern corresponds to a periodic radar signal of constant frequency.

15. The method according to claim 12, wherein the determined radar pulse pattern is transmitted by a further radar sensor in a cooperation mode at a rear vehicle end of the rail vehicle with respect to the direction of travel.

16. The method according to claim 12, wherein the determined radar pulse pattern corresponds to a radar signal with variable period and/or variable frequency, wherein the variable period and/or the variable frequency is set according to a measurement of distance and/or speed and/or direction of travel of an object present in a detection range by the radar sensor operating in cooperation mode.

17. The method according to claim 16, wherein the measurement of the distance and/or the speed and/or the direction of travel of an object present in the detection range is carried out by the radar sensor operating in cooperation mode during a first time period in periodic alternation with the transmission of the determined radar pulse pattern during a second time period.

18. The method according to claim 12, wherein a signal is given when an approaching object is detected and there is a risk of collision.

19. A device, including a control unit, for a rail vehicle with radar sensors arranged at both vehicle ends, wherein the device is configured to:
carry out an object detection of upcoming obstacles and objects by operating a radar sensor in a direction of travel in normal mode, in which an obstacle detection of approaching objects ahead in a roadway is carried out based on a radar detection; and
detect an approaching object when a superimposed determined radar pulse pattern is received in a radar detection with a radar sensor in normal mode, wherein the determined radar pulse pattern corresponds to a radar pulse pattern that deviates from a radar transmission signal in normal operation.

20. A system, comprising:
at least two radar sensors which can be arranged at two vehicle ends of a rail vehicle; and
a device, including a control unit, for the rail vehicle, wherein the device is configured to:
carry out an object detection of upcoming obstacles and objects by operating a radar sensor in a direction of travel in normal mode, in which an obstacle detection of approaching objects ahead in a roadway is carried out based on a radar detection; and
detect an approaching object when a superimposed determined radar pulse pattern is received in a radar detection with a radar sensor in normal mode, wherein the determined radar pulse pattern corresponds to a radar pulse pattern that deviates from a radar transmission signal in normal operation.

21. A non-transitory machine-readable storage medium on which is stored a computer program for operating a rail vehicle with radar sensors arranged at both vehicle ends, the computer program, when executed by a computer, causes the computer to perform the following steps:
carrying out an object detection of upcoming obstacles and objects by operating a radar sensor in a direction of travel in normal mode, in which an obstacle detection of approaching objects ahead in a roadway is carried out based an a radar detection; and
detecting an approaching object when a superimposed determined radar pulse pattern is received in a radar detection with the radar sensor in normal mode, wherein the determined radar pulse pattern corresponds to a radar pulse pattern that deviates from a radar transmission signal in normal operation.
